(19) United States
(12) Patent Application Publication
(10) Pub. No.: US 2009/0317082 A1
(43) Pub. Date: Dec. 24, 2009

(54) Passive Optical Network System, Optical Network Unit, and Optical Line Terminal

(76) Inventors: Mitsunobu KIMURA, Yokohama (JP); Yusuke Yajima, Fujisawa (JP); Masahiko Mizutani, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/486,104

(22) Filed: Jun. 17, 2009

(30) Foreign Application Priority Data
Jun. 19, 2008 (JP) 2008-160539

(51) Int. Cl. H04J 14/00

(52) U.S. Cl. 398/67

(57) ABSTRACT

An optical line terminal (OLT), an optical network unit (ONT) and a passive optical network (PON) system are provided. A user of the ONU or a terminal connected with the ONU can accurately recognize the amount of a bandwidth allocated to the ONU without estimating the communication bandwidth. The OLT notifies each ONU of the amount of the bandwidth allocated to the ONU in response to a request transmitted from the ONU to the OLT. Each ONU receives bandwidth information from the OLT and displays thereon the bandwidth information or notifies the terminal connected with the ONU of the bandwidth information.

### CLAIM OF PRIORITY

The present application claims priority from Japanese patent application serial no. 2008-160539, filed on Jun. 19, 2008, the content of which is hereby incorporated by reference into this application.

### BACKGROUND OF THE INVENTION

The present invention relates to a passive optical network system, an optical network unit and an optical line terminal, and more particularly to a passive optical network system having a plurality of optical network units that share an optical fiber, and an optical network unit and an optical line terminal that are included in the passive optical network system having the plurality of optical network units.

A passive optical network (PON) system includes an optical line terminal (OLT) and a plurality of optical network units (ONUs). The PON system receives a signal from a terminal (PC or the like) connected with any of the ONUs and converts the received signal into an optical signal. Then, the PON system causes the optical signal to passes through the ONU, a branch optical fiber and an optical splitter. The PON system then optically (time-division) multiplexes the optical signal and sends the optical signal to the OLT through a trunk optical fiber extending to the OLT. The OLT receives the optical signal and performs various types of signal processing. As a result, the PON system performs communications between a terminal connected with a certain ONU included in the PON system and a terminal connected with another ONU included in the PON system or between the terminal connected with the certain ONU and a terminal connected with the network system.

Data transmitted from the OLT to the ONUs is called a downstream signal. The downstream signal is transmitted to all of the ONUs through the one trunk optical fiber and all branch optical fibers that are connected with the optical splitter and with the respective ONUs. Each of the ONUs extracts only its own data included in the received signal. Thus, the OLT allocates downstream bandwidths (data transmission regions/times) available for the ONUs to the ONUs respectively in order to prevent a certain one of the ONUs from occupying the downstream signal.

A dynamic bandwidth allocation (DBA) technique is defined by ITU-T Recommendation G.983.4. In the DBA technique, an OLT allocates upstream bandwidths (data transmission regions/times) to respective ONUs so that one optical fiber is shared with many ONUs and the OLT evenly transmits a large amount of data to as many ONUS as possible in response to requests from users of the ONUs. Furthermore, the bandwidths are controlled according to this technique.

In the definitions of Clause 8.2 of ITU-T Recommendation G.984.3, each of signals transmitted from a plurality of ONUs to an OLT is called an upstream signal. The upstream signal is consists essentially of a preamble, a delimiter and a payload signals. As described in Clause 8 of ITU-T Recommendation G.984.3, a guard time is set immediately before transmission of each upstream signal in order to prevent undesirable collision with a previous burst signal. Also note that according to the definitions of Clause 8.1 of this ITU-T Recommendation G.984.3, a signal to be sent from the OLT to two or more ONUs is consists essentially of a frame sync pattern, a physical layer operations, administration and maintenance (PLOAM) field, an upstream bandwidth map field, and a frame payload. It should be noted that two or more bandwidth allocation units, called transmission containers (T-CONTs), are allocated to each ONU. Upstream signal transmission grant timings are specified for each T-CONTs.

### SUMMARY OF THE INVENTION

Each of the ONUs is not notified of the amounts of the downstream and upstream bandwidths allocated to the ONU. The bandwidths allocated to each of the ONUs are not recognized by the user of the ONU or a terminal connected with the ONU. Thus, the ONU used by the user or the terminal estimates the amounts of allocated bandwidths by measuring the bandwidths or performing another operation and then performs data communications. Therefore, the communications may be unstable due to the estimation. In addition, the ONU may attempt to transmit and receive data whose amount is larger than the amount of data capable of being transferred at the bandwidth allocated to the ONU. In this case, an excess packet is discarded. Additionally a terminal which reproduces streaming video data of a high bit rate may receive data whose amount is larger than the amount of data capable of being transferred at the bandwidth used between the terminal and the ONU. In this case, the streaming video data is cut.

The present invention provides an OLT, an ONU and a PON system, which allow a user of any of ONUs or a terminal connected with the ONU to accurately recognize the amount of a bandwidth allocated to the ONU and prevent the terminal from performing an unstable operation caused by the fact that the terminal does not recognize the amount of the allocated bandwidth.

The OLT notifies each ONU of the amount of a bandwidth allocated to the ONU, and each ONU displays thereon information on the bandwidth allocated to the ONU. Alternatively, the OLT notifies the terminal connected with the ONU of the bandwidth allocated to the ONU. In order to notify the ONU or the terminal of the amount of the bandwidth, (1) the OLT transmits bandwidth setting information (that is also called bandwidth information in this specification) to the ONU in response to an inquiry from the ONU by means of an ONT management control interface (OMCI) message that is used for communications between the OLT and ONU; (2) the OLT transmits the bandwidth information in response to an inquiry message from the terminal connected with the ONU; or the like.

The passive optical network (PON) system includes the optical network unit (ONU) and the optical line terminal (OLT), which are connected with each other through an optical fiber; the optical line terminal has a bandwidth setting information storage section; and when the optical line terminal receives a bandwidth information inquiry message from the optical network unit, the optical line terminal references the bandwidth setting information storage section and transmits a bandwidth information response message including bandwidth information.

The optical network unit is connected with the optical line terminal through the optical fiber and has a message transmitter and a message receiver; and when the message transmitter transmits the bandwidth information inquiry message and the message receiver receives the bandwidth information response message, the optical network unit displays or transfers the bandwidth information included in the bandwidth information response message.

The optical line terminal is connected with the optical network unit through the optical fiber and has a message transmitter, a message receiver and the bandwidth setting information storage section; and when the message receiver receives the bandwidth information inquiry message from the optical network unit, the optical network unit references the bandwidth setting information storage section, and the message transmitter transmits the bandwidth information response message including the bandwidth information.

Using the PON system, the ONU user can accurately recognize the setting of the bandwidth used for communications between the ONU and the OLT.

### BRIEF DESCRIPTION OF THE DRAWINGS

Preferred embodiments of the present invention will now be described in conjunction with the accompanying drawings, in which;

FIG. 1 is a block diagram showing an optical access network.

FIG. 2 is a diagram showing an optical signal present in a trunk optical fiber.

FIG. 3 is a diagram showing setting of a bandwidth used in the optical access network.

FIG. 4 is a block diagram showing an ONU.

FIG. 5 is a front view of the ONU.

FIG. 6 is a functional block diagram showing the OLT.

FIG. 7 is a block diagram showing operations of a grant generator and peripheral parts of the grant generator.

FIG. 8 is a block diagram showing a downstream bandwidth shaper and peripheral parts of the downstream bandwidth shaper.

FIG. 9 is a block diagram showing a bandwidth information generator.

FIG. 10 shows a format of an OMCC frame.

FIG. 11 is a diagram showing a message content of a downstream signal.

FIG. 12 is a diagram showing a message content of an upstream signal.

FIG. 13 is a flowchart of operations of the OLT, which are related to a notification of bandwidth information.

FIG. 14 is a flowchart of bandwidth information request processing performed by the ONU.

FIG. 15 is a diagram showing a sequence of the OLT and three ONUs.

FIG. 16 is another flowchart of operations of the OLT, which are related to the notification of bandwidth information.

FIG. 17 is still another flowchart of operations of the OLT, which are related to the notification of bandwidth information.

FIG. 18 is a diagram showing another setting of the bandwidth used in the optical access network.

FIG. 19 is a diagram showing still another setting of the bandwidth used in the optical access network.

### DESCRIPTION OF THE PREFERRED EMBODIMENT

Embodiments of the present invention are described with reference to the accompanying drawings. It should be noted that the same elements are denoted by the same reference numerals and descriptions thereof are not repeated.

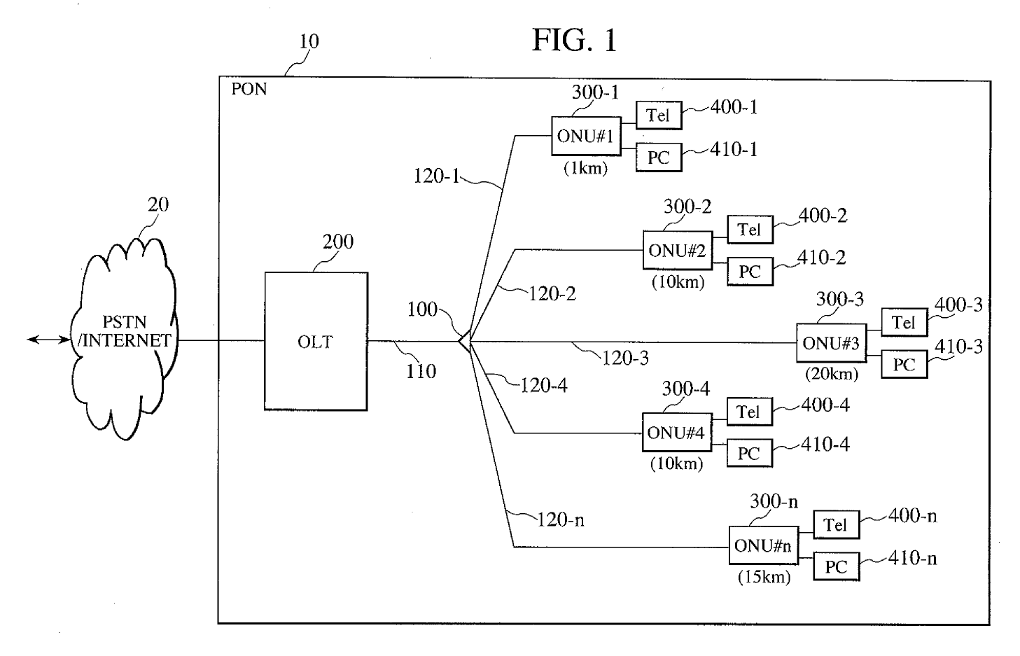

The configuration of an optical access network is described with reference to FIG. 1. FIG. 1 is a block diagram showing the optical access network. In FIG. 1, reference numeral 10 denotes a passive optical network (PON) system. The PON system 10 is connected with the public switched telephone network (PSTN)/Internet 20 and transmits and receives data through the PSTN/Internet 20. The PON system 10 includes an optical splitter 100, a trunk optical fiber 110, branch optical fibers 120, an optical line terminal (OLT) 200, optical network units (ONUs) 300, phones 400 and personal computers (PCs) 410.

The OLT 200 can be connected with thirty two ONUs 300 through the trunk optical fiber 110, the optical splitter and thirty two branch optical fibers 120. Five ONUs are shown in FIG. 1. The lengths of the optical fibers provided between the five ONUs and the OLT 200 are different from each other. In an example shown in FIG. 1, the length of the optical fibers (110 and 120-1) provided between the ONU 300-1 and the OLT 200 is 1 km. The length of the optical fibers (110 and 120-2) provided between the ONU 300-2 and the OLT 200 is 10 km. The length of the optical fibers (110 and 120-3) provided between the ONU 300-3 and the OLT 200 is 20 km. The length of the optical fibers (110 and 120-4) provided between the ONU 300-4 and the OLT 200 is 10 km. The length of the optical fibers (110 and 120-n) provided between the ONU 300-n and the OLT 200 is 15 km.

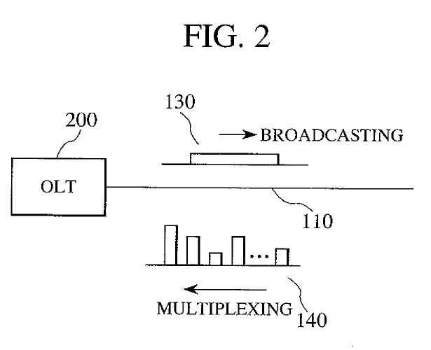

FIG. 2 is a diagram showing an optical signal that is transferred in the trunk optical fiber 110. In FIG. 2, reference numeral 130 denotes a downstream optical signal, and reference numeral 140 denotes an upstream optical signal. The downstream optical signal 130 is transferred in the trunk optical fiber 110 and broadcasted to all of the ONUs 300. The upstream optical signal 140 is transmitted from any of the ONUs 300 and time division multiplexed by the optical splitter 100. A method for controlling a bandwidth for the downstream optical signal is different from a method for controlling a bandwidth for the upstream optical signal. A pair of the bandwidths for the downstream and upstream optical signals is allocated to each of the ONUs 300.

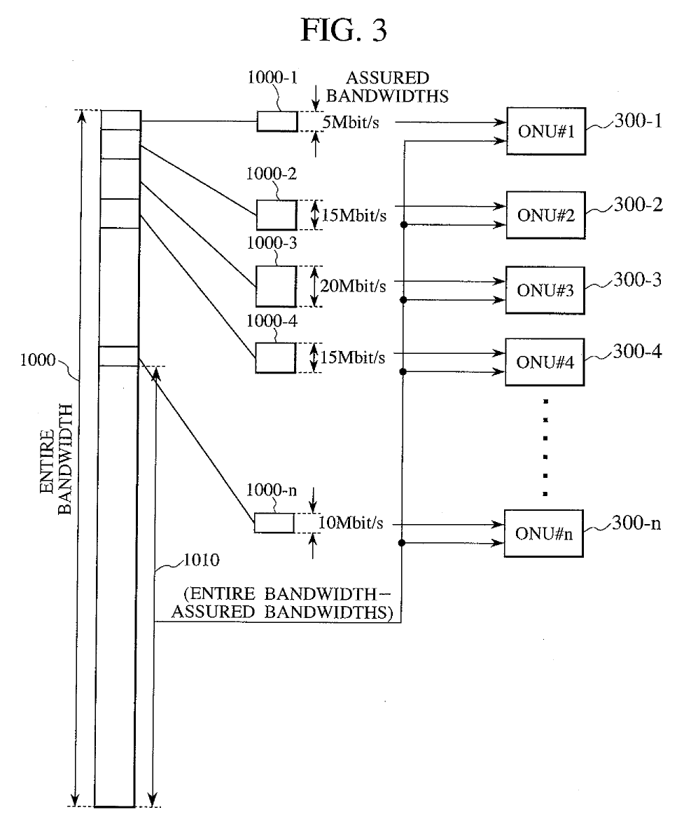

FIG. 3 is a diagram showing setting of a bandwidth used in the optical access network. In FIG. 3, the bandwidth is denoted by reference numeral 1000. The entire bandwidth 1000 used in the optical access network includes bandwidths 1000-1 to 1000-n that are respectively previously assured for the ONUs 300-1 to 300-n. Specifically, the bandwidth 1000-1 of 5 Mbit/s is allocated to the ONU 300-1, and the bandwidth 1000-2 of 15 Mbit/s is allocated to the ONU 300-2. The other bandwidths 1000-3 to 1000-n are allocated to the other ONUs 300-3 to 300-n, respectively, as shown in FIG. 3. The remaining bandwidth obtained by removing the assured bandwidths 1000-1 to 1000-n from the entire bandwidth 1000 is denoted by reference numeral 1010. All portions of the remaining bandwidth 1010 are respectively allocated to the ONUs 300-1 to 300-n based on the ratios of the assured bandwidths 1000-1 to 1000-n relative to the total of the assured bandwidths 1000-1 to 1000-n. The amounts of the portions (of the bandwidth 1010) to be respectively allocated to the ONUs 300-1 to 300-n are changed every time the assured bandwidths 1000-1 to 1000-n are changed.

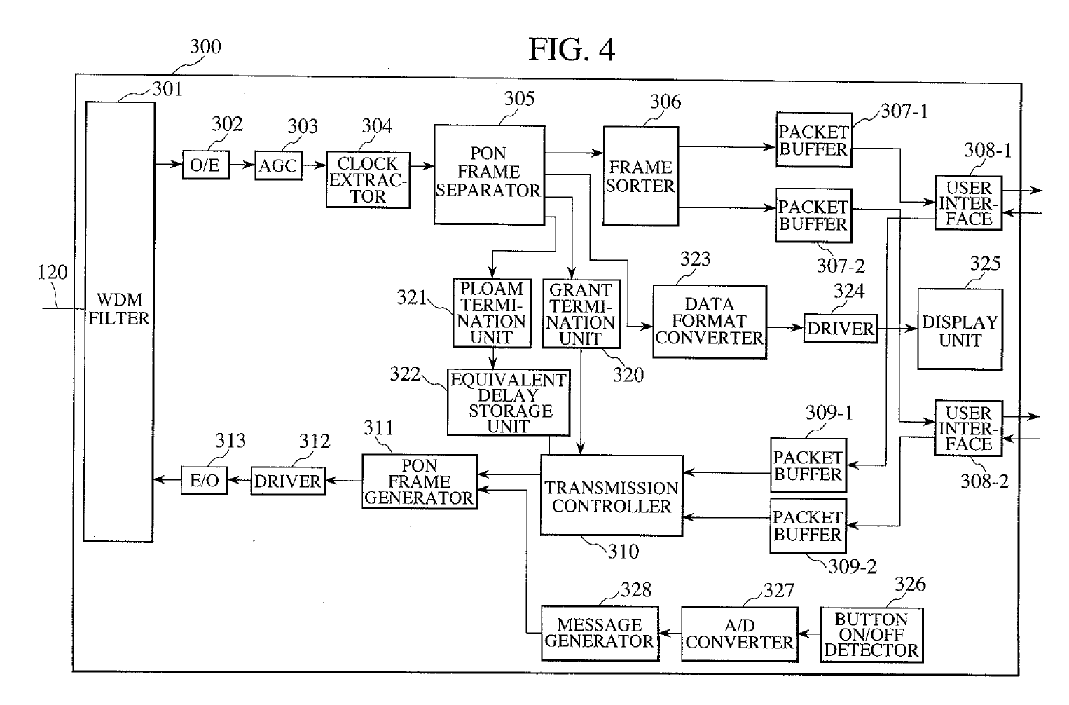

FIG. 4 is a block diagram showing the configuration of the ONU 300. Each of the ONUs 300 has a wavelength division multiplexing (WDM) filter 301, an optical-to-electrical (O/E) converter 302, an automatic gain controller (AGC) 303, a clock extractor 304, a PON frame separator 305, a frame sorter 306, two packet buffers 307-1, 307-2 and user interfaces 308, which are arranged in the direction in which the downstream optical signal is transferred. Each of the ONUs 300 has user interfaces 308, two packet buffers 309, a transmission controller 310, a PON frame generator 311, a driver 312, an electrical-to-optical (E/O) converter 313, and the WDM filter 301, which are arranged in the direction in which the upstream optical signal is transferred. Furthermore, each of the ONUs 300 has a physical layer operation administration and maintenance (PLOAM) termination unit 321, a grant termination unit 320, a data format converter 323, a driver 324, a display unit 325, an equivalent delay storage unit 322, an inquiry button ON/OFF detector 326, an analog-to-digital (A/D) converter 327, and a message generator 328.

After the ONU 300 receives the downstream optical signal through the branch optical fiber 120, the WDM filter 301 wavelength-division demultiplexes the downstream optical signal and the upstream optical signal. The O/E converter 302 converts the downstream optical signal into an electrical signal. The AGC 303 performs control to make the amplitude of the converted signal constant. The clock extractor 304 performs retiming on the signal. The PON frame separator 305 separates the multiplexed signal. The PON frame separator 305 transmits a PLOAM signal to the PLOAM termination unit 321 and transmits a grant instruction signal to the grant termination unit 320. The PON frame separator 305 transmits a frame payload signal to the frame sorter 306. The frame sorter 306 sorts user signals into the packet buffers 307-1 and 307-2. The user signals are temporarily stored in the packet buffers 307-1 and 307-2 and then output from the ONU 300 through the user interfaces 308-1 and 308-2.

The signals input to the user interfaces 308-1 and 308-2 are temporarily stored in the packet buffers 309-1 and 309-2, respectively. Then, the signals are read out by the transmission controller 310. The PON frame generator 311 generates a PON frame based on the upstream signals and outputs a PON frame signal. The driver 312 converts the PON frame signal into a current signal. The E/O converter 313 converts the electrical signal (current signal) to an optical signal. The E/O converter 313 outputs the upstream optical signal to the branch optical fiber 120 through the WDM filter 301.

The transmission controller 310 adds an equivalent delay value extracted from the PLOAM termination unit 321 and stored in the equivalent delay storage unit 211 to a transmission permission value extracted from the grant termination unit 320. The transmission controller 310 then transmits the thus added value to the OLT 200. The inquiry button ON/OFF detector 326 detects an ON state of an inquiry button (described later). The A/D converter 327 converts a signal indicating the ON state into a digital signal. The message generator 328 generates an OMCI message that requests the OLT 200 to transmit bandwidth information. The PON frame generator 311 generates a PON frame based on the upstream user signals and the OMCI message. The driver 312 converts the PON frame signal into a current signal. The E/O converter 313 converts an electrical signal into an optical signal and transmits the upstream optical signal to the OLT 200 through the WDM filter 301 and the branch optical fiber 120.

The OLT 200 transmits a signal including bandwidth information to the ONU 300 in response to the OMCI message. The bandwidth information included in the signal is extracted by the PON frame separator 305. The data format converter 323 receives an OMCI message including the bandwidth information from the PON frame separator 305 and converts the format of the bandwidth information into a format that allows the bandwidth information to be displayed. The driver 324 drives the display unit 325. The display unit 325 displays the bandwidth information. The data format converter 323 may directly transmit the bandwidth setting information to the phone 400 and the PC 410 which are connected with the ONU 300. The phone 400 and the PC 410 may cause the message generator 328 to generate an OMCI message that requests the OLT 200 to transmit the bandwidth information.

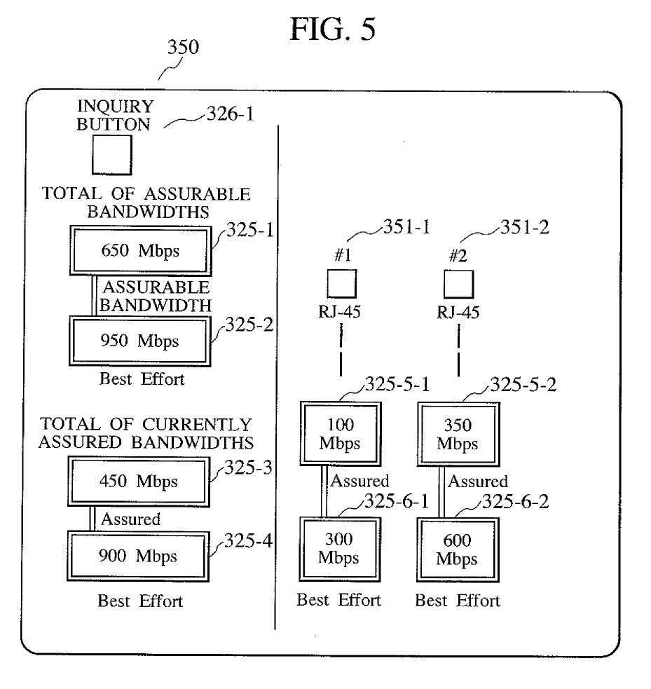

FIG. 5 is a front external view of the ONU. In FIG. 5, reference numeral 350 denotes a front portion of the ONU 300, and reference numeral 326-1 denotes the inquiry button described above. The ONU 300 has, on the front portion 350, the inquiry button 326-1, current time bandwidth information display units 325-3, 325-4, assurable bandwidth setting information display units 325-1, 325-2, RJ-45 connectors 351-1, 351-2, currently assured bandwidth information display units 325-5-1, 325-5-2, and best effort bandwidth information display units 325-6-1, 325-6-2.

The inquiry button 326-1 is connected with the inquiry button ON/OFF detector 326. The display unit 325 uses a LED or liquid crystal and displays a value. The bandwidth information display unit 325-3 displays a bandwidth that is assured for the ONU 300 at a current time. The bandwidth information display unit 325-4 displays the amount of the maximum bandwidth that is used for communications performed with the best effort value by the ONU 300 at a current time. The assurable bandwidth setting information display unit 325-1 displays an estimated value for convenience of a user of the ONU 300. The bandwidth setting information display unit 325-2 displays the maximum bandwidth used for communications performed with the best effort value obtained when the ONU follows the estimated value.

When the number of ports included in the ONU 300 is one, only the bandwidth setting information display units 325-1 to 325-4 are provided. In this example, since the number of ports is two, Alloc IDs are allocated to the ports respectively, and bandwidths that are to be used by the respective ports are set. The currently assured bandwidth setting information display unit 325-5-1 and the best effort bandwidth setting information display unit 325-6-1 are provided for the RJ-45 connector 351-1, while the currently assured bandwidth setting information display unit 325-5-2 and the best effort bandwidth setting information display unit 325-6-2 are provided for the RJ-45 connector 351-2.

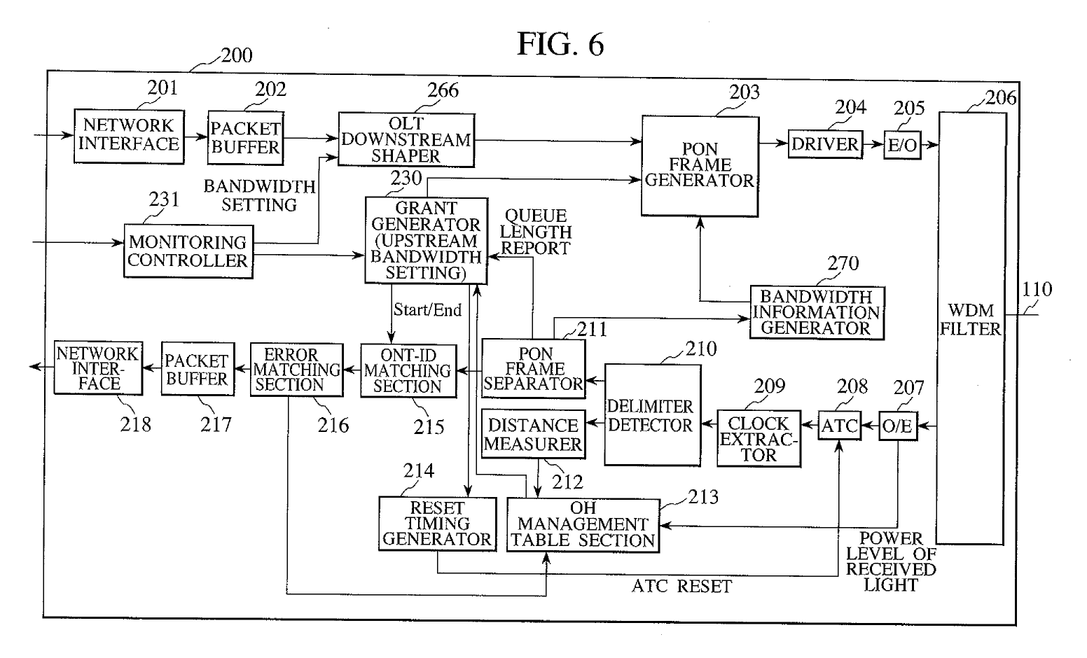

FIG. 6 is a functional block diagram showing the OLT 200. In FIG. 6, the OLT 200 has a network interface 201, a packet buffer 202, an OLT downstream shaper 266, a PON frame generator 203, a driver 204, an E/O converter 205 and a WDM filter 206, which are arranged in the direction in which the downstream optical signal is transferred. The OLT 200 has the WDM filter 206, an O/E converter 207, an automatic threshold controller (ATC) 208, a clock extractor 209, delimiter detector 210, a PON frame separator 211, an ONT-ID matching section 215, an error matching section, 216, a packet buffer 217 and a network interface 218, which are arranged in the direction in which the upstream optical signal is transferred. The OLT 200 also has a monitoring controller 231, a grant generator 230, a bandwidth information generator 270, a distance measurer 212, an OH management table section 213, and a reset timing generator 214.

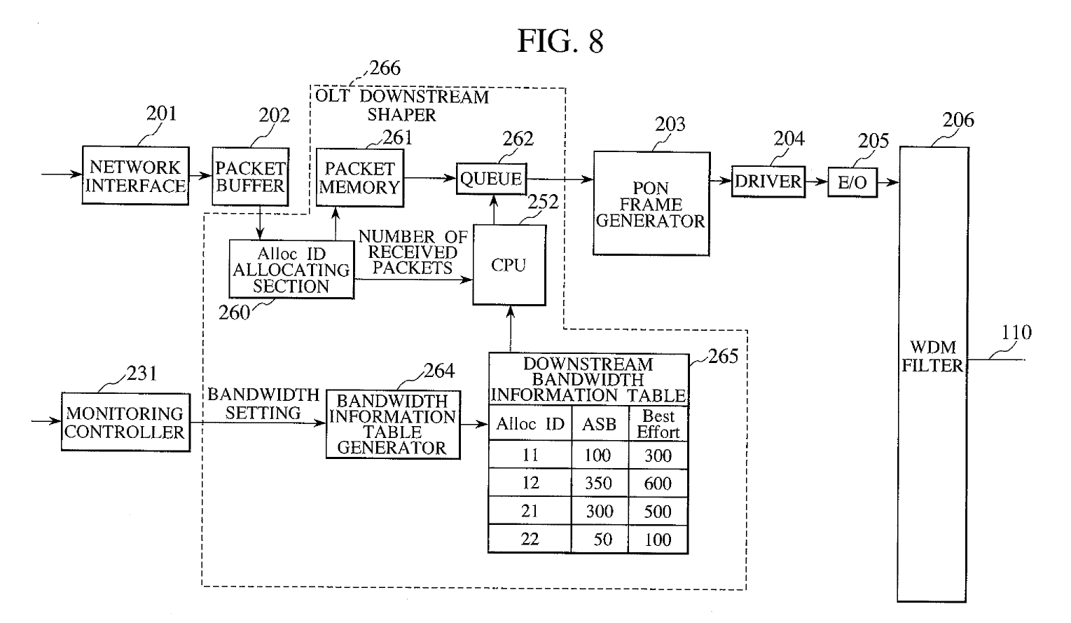

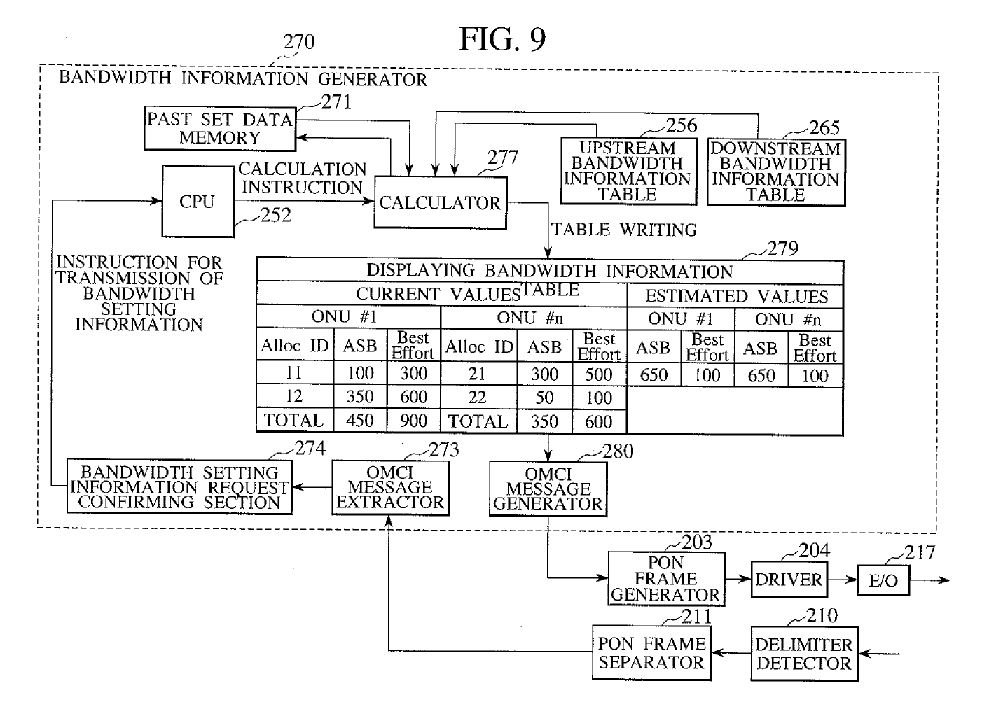

The network interface 201 receives a signal through the PSTN/Internet 20. This signal is temporarily stored in the packet buffer 202. The OLT downstream shaper 266 reads a packet from the packet buffer 202 and transmits the read packet to the PON frame generator 203. Operations of the OLT downstream shaper 266 are described later with reference to FIG. 8. The PON frame generator 203 causes an PON downstream frame signal to include the signal output from the OLT downstream shaper 266, a signal output from the grant generator 230 and a signal output from the bandwidth information generator 270. The PON frame generator 203 transmits the thus formed signal to the driver 204. The driver 204 converts the voltage signal generated by the PON frame generator 203 into a current signal. The E/O converter 205 uses the current signal to modulate continuous light and thereby generate an optical signal. The E/O converter 205 transmits the generated optical signal to the trunk optical fiber 110 through the WDM filter 205. Operations of the bandwidth information generator 270 are described later with reference to FIG. 9.

The OLT 200 receives the upstream optical signal through the trunk optical fiber 110. The WDM filter 206 wavelength-division multiplexes the upstream optical signal. The O/E converter 207 converts the optical signal into an electrical signal. The ATC 208 identifies whether a value of the electrical signal is zero or one based on an appropriate threshold. The clock extractor 209 extracts a clock of the signal and performs retiming. The delimiter detector 210 identifies a boundary of the upstream signal. The PON frame separator 211 separates the PON frame and transmits a queue length report stored in a queue length region to the grant generator 230. The distance measurer 212 measures a distance between the OLT 200 and the ONU 300. The measured value (distance) is stored in the OH management table section 213.

The OH management table section 213 receives a power level of received light from the O/E converter 207 and stores the power level of the received light therein. The OH management table section 213 has a table for outputting an appropriate guard time value for each ONU 300. The OH management table section 213 outputs the guard time value to the grant generator 230. The grant generator 230 uses a bandwidth setting value received from the monitoring controller 231, the queue length report received from the PON frame separator 211, and the guard time value received from the OH management table section 213 to generate a start value and a stop value. The grant generator 230 passes the start value and the stop value to the reset timing controller 214. The reset timing controller 214 resets the ATC 208 in synchronization with the length of a guard time changed for each ONU 300.

The ONT-ID matching section 215 checks whether or not a signal output from the PON frame separator 211 matches a signal transmitted from a specified one of the ONUs 300. The error matching section 216 calculates the number of error bits included in a signal received from each ONU 300. The error matching section 216 sends data on the number of error bits to the OH management table section 213. The number of error bits is used to calculate the length of the optimal guard time. The error matching section 216 outputs a user signal to the packet buffer 217. The packet buffer 217 temporarily stores the user signal. The user signal is sent to the PSTN/Internet 20 through the network interface 218.

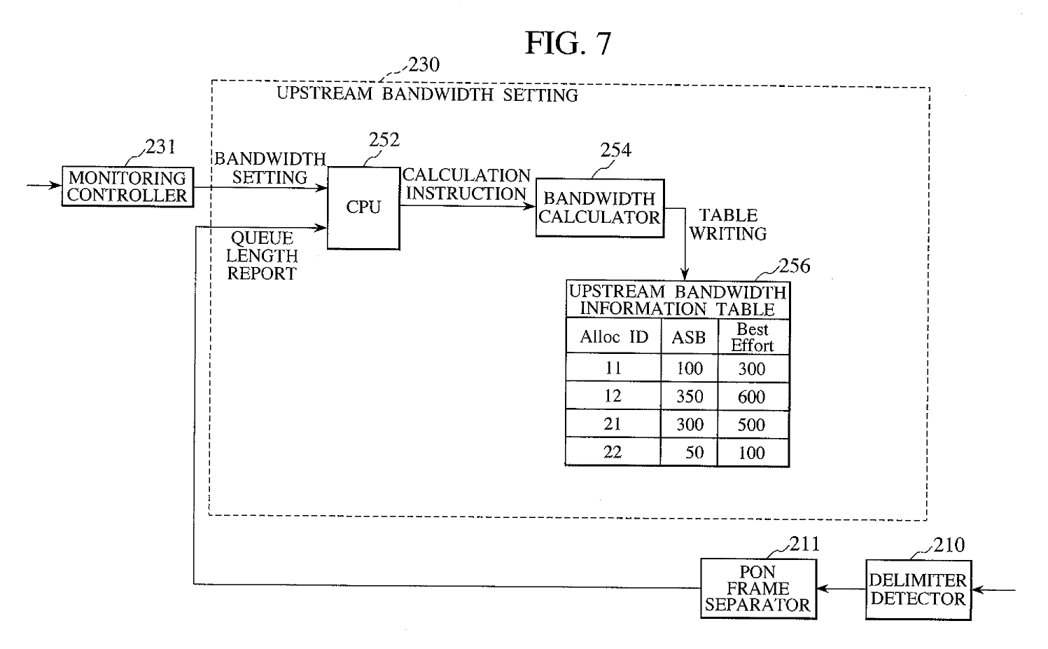

With reference to FIG. 7, generation of upstream bandwidth information by the grant generator 230 is described. FIG. 7 is a block diagram showing operations of the grant generator 230 and peripheral parts of the grant generator 230. The grant generator 230 includes a CPU 252, a bandwidth calculator 254 and an upstream bandwidth information table 256.

The CPU 252 receives an instruction for setting a bandwidth from the monitoring controller 231. In response to the instruction, the CPU 252 sends a calculation instruction to the bandwidth calculator 254. The bandwidth calculator 254 outputs table writing information. The upstream bandwidth information table 256 is updated based on the table writing information. The bandwidth information table 256 stores an assured bandwidth and a best effort bandwidth for each Alloc ID.

The CPU 252 receives the queue length report obtained by the delimiter detector 210 and the PON frame separator 211. The CPU 252 transmits a calculation instruction to the bandwidth calculator 254 again. The bandwidth calculator 254 receives the calculation instruction from the CPU 252 and updates the bandwidth information table 226 in accordance with the received calculation instruction. When a value indicated by the queue length report is larger than the set maximum bandwidth of the corresponding Alloc ID, the set maximum bandwidth is used.

FIG. 8 is a block diagram showing the OLT downstream shaper and peripheral parts of the OLT downstream shaper. In FIG. 8, the OLT downstream shaper 266 has an Alloc ID allocating section 260, a packet memory 261, a queue 262, a CPU 252, a bandwidth information generator 264, and a downstream bandwidth information table 265. The network interface 201 cause the packet buffer 202 to store a packet received by the network interface 201. The Alloc ID allocating section 260 reads the packet from the packet buffer 202. The Alloc ID allocating section 260 identifies an Alloc ID (that is a destination of the packet) based on the header of the read packet, and allocates the Alloc ID to the packet. The Alloc ID allocating section 260 reports the number of received packets to the CPU 252 for each Alloc ID. The packet is stored in the packet memory 261 and subsequently transferred to the queue 262. The queue 262 sends the packet to the PON frame generator 203 at a timing instructed by the CPU 252.

The CPU 252 calculates an allocation time for each Alloc ID based on contents of the downstream bandwidth information table 265 in order to instruct the queue 262 to transfer the packet. When the OLT 200 receives packets to which a certain Alloc ID is to be allocated and of which the number is larger than an assured bandwidth allocated to the certain Alloc ID, the CPU 252 sums up the number of packets of which the number is larger than an assured bandwidth allocated to another Alloc ID. After that, the CPU 252 reallocates a bandwidth to each Alloc ID without exceeding the best effort bandwidth. The monitoring controller 231 transmits bandwidth setting information 263 to the bandwidth information table generator 264. The bandwidth information table generator 264 generates contents of the downstream bandwidth information table 265 based on the bandwidth setting information 263. The OLT downstream shaper 266 outputs to the downstream side thereof a packet capable of being transferred at a bandwidth allocated to each Alloc ID while the amount of the packet is not larger than the capacity of the packet memory 261.

FIG. 9 is a block diagram showing the bandwidth information generator 270. The bandwidth information generator 270 has an OMCI message extractor 273, a bandwidth setting information request confirming section 274, a CPU 252, a calculator 277, a past set data memory 271, an upstream bandwidth information table 256, a downstream bandwidth information table 265, a displaying bandwidth information table section 279, and an OMCI message generator 280.

As described above with reference to FIGS. 4 and 5, when the inquiry button 326-1 is pressed, the ONU 300 transmits the request for a notification of bandwidth setting information by means of the OMCI message. The signal (request) passes through the delimiter detector 210 and the PON frame separator 211 and is then received by the OMCI message extractor 273. The signal is extracted by the OMCI message extractor 273 and then recognized by the bandwidth setting information request confirming section 274. The bandwidth setting information request confirming section 274 then transmits to the CPU 252 an instruction for transmission of bandwidth setting information. The CPU 252 transmits a calculation instruction to the calculator 277. The calculator 277 calculates bandwidth information for display and outputs a table write signal to the displaying bandwidth information table section 279. The displaying bandwidth information table section 279 rewrites contents of its displaying bandwidth information table. The displaying bandwidth information table section 279 acquires an assured bandwidth value and best effort value of each of the Alloc IDs allocated to the respective ONUs 300, the total of the assured bandwidth values of the ONUs 300, and the total of the best effort values of the ONUs 300 from the upstream bandwidth information table 256 and the downstream bandwidth information table 265. In this case, lower ones of the assured bandwidth values included in the upstream bandwidth information table 256 and in the downstream bandwidth information table 265, and lower ones of the best effort values included in the upstream bandwidth information table 256 and in the downstream bandwidth information table 265, are used. The displaying bandwidth information table section 279 calculates an estimated assured bandwidth value and an estimated best effort value that are available for each ONU. The calculation of the estimated values is performed using a several algorithms (described later). Past set information can be read from the past set data memory 271 and used to calculate the estimated values. In this case, every time the calculator 277 performs the processing, the results of the calculation is stored in the past setting data memory 271 to be used for a future calculation. When the displaying bandwidth information table section 279 is completely updated, the updated contents of the displaying bandwidth information table section 279 are sent to the OMCI message generator 280. The OMCI message generator 280 edits an OMCI message to obtain an OMCC (ONT management control channel) frame and sends the OMCC frame to the PON frame generator 203. The PON frame generator 203 converts the OMCC frame into a PON frame.

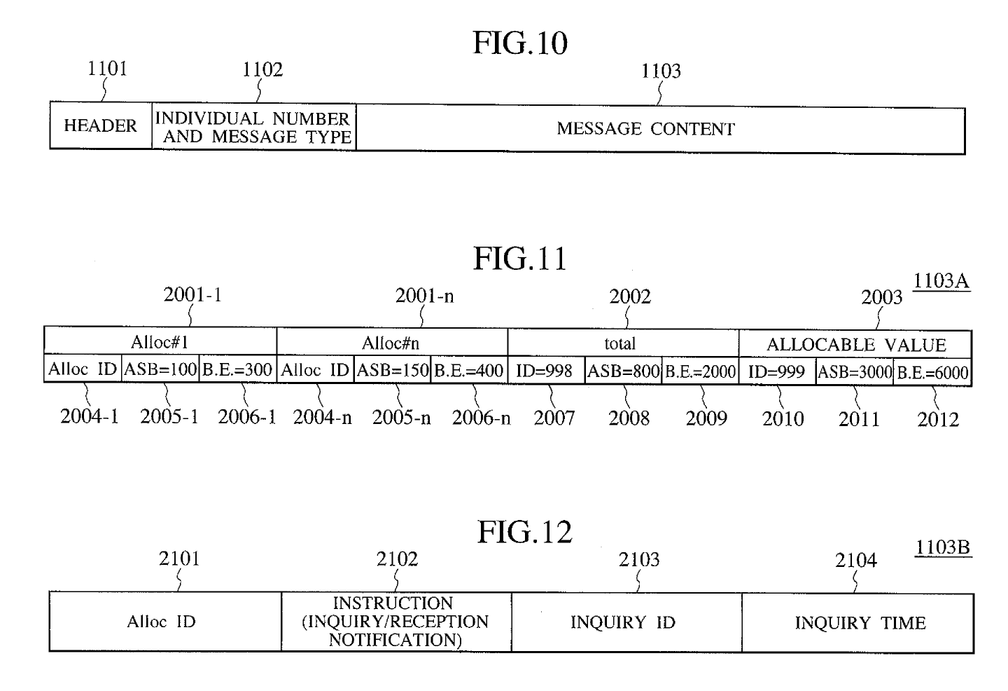

FIG. 10 is a diagram showing a format of the OMCC frame constituting the OMCI message. In FIG. 10, the OMCC frame has a header 1101, an individual number and message type 1102 and a message content 1103.

FIG. 11 is a diagram showing the message content of the OMCC frame included in the downstream signal. FIG. 11 shows the case where the number of Alloc IDs is n. In FIG. 11, the message content 1103A included in the downstream signal has a signal 2001-1 for Alloc #1, a signal 2001-2 for Alloc #2, . . . , a signal 2002 for the total of the Alloc #1 to #n, and a signal 2003. The signal 2003 indicates the sum of calculated values allocable to all of the Alloc #1 to #n. The signal 2001-m (m is between 1 and n) for Alloc #m has an Alloc ID region 2004-m, an assured bandwidth (ASB) value 2005-m and a best effort value 2006-m.

The ASB value 2005-m indicates the amount of a currently assured bandwidth. The best effort value 2006-m indicates a currently set best effort bandwidth value. An Alloc ID 2007 of the signal 2002 indicates 998. An ASB value 2008 (indicating 800 in this case) indicates the sum of bandwidths assured for all of the Alloc #1 to #n. A best effort value 2009 (indicating 2000 in this case) indicates the sum of the best effort values assured for all of the Alloc #1 to #n.

An Alloc ID 2010 of the signal 2003 indicates 999. An ASB value 2011 (indicating 3000 in this case) indicates the sum of bandwidths allocable to all of the Alloc #1 to #n. A best effort value 2012 (indicating 6000 in this case) indicates the sum of all of the best effort values allocable to all of the Alloc #1 to #n.

FIG. 12 is a diagram showing the message content of the OMCC frame included in the upstream signal. In FIG. 12, the message content 1103B has an Alloc ID 2101, an instruction 2102 and an inquiry ID 2103 and an inquiry time 2104. The instruction 2102 specifies in advance values that mean an inquiry and a reception completion notification. A value is written in the instruction 2102 for the purpose of transmission of the message. The inquiry ID 2103 is counted by each ONU 300 and transmitted together with the Alloc ID. Thus, an inquiry ID 2103 to a certain one of the ONUs 300 and an inquiry ID 2103 to another one of the ONUs 300 can be duplicated. When one ONU has multiple Alloc IDs, the message may be transmitted according to any of the Alloc IDs.

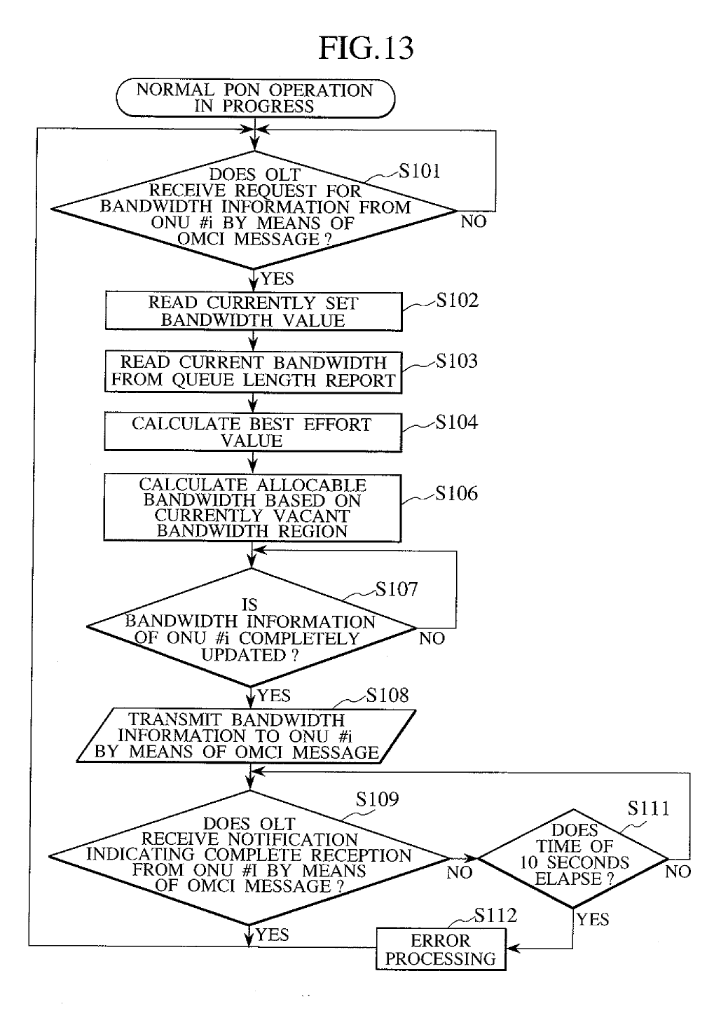

FIG. 13 is a flowchart of operations of the OLT, which are related to a notification of bandwidth information. Referring to FIG. 13, the OLT 200 waits for a request for bandwidth information from the ONU in S101. When the OLT 200 receives the request from the ONU #i (YES in S101), the OLT 200 reads information on a bandwidth currently set to the ONU #i in S102. The OLT 200 then reads a bandwidth currently used for the ONU #i from the queue length report in S103. The OLT 200 calculates a best effort value for the ONU #i based on the read values in S104. The OLT 200 calculates a bandwidth region allocable to the ONU #i based on information on a currently vacant bandwidth region in S106. The OLT 200 determines whether or not the bandwidth information of the ONU #i is completely updated, in S107. When the OLT 200 determines that the bandwidth information of the ONU #i is completely updated (YES in S107), the OLT 200 transmits the updated bandwidth information to the ONU #i by means of an OMCI message in S108. The OLT 200 determines whether or not the OLT 200 receives from the ONU #i a notification indicating that the ONU #i completely receives the OMCI message, in S109. When the answer is YES in S109, the OLT 200 returns back to S101. When the answer is NO in S109, the OLT 200 determines whether or not a time of 10 seconds elapses after the transmission of the OMCI message indicating the updated bandwidth information, in S111. When the answer is YES in S111, the OLT 200 performs error processing in S112 and returns back to S101. When the answer is NO in S111, the OLT 200 returns back to S109.

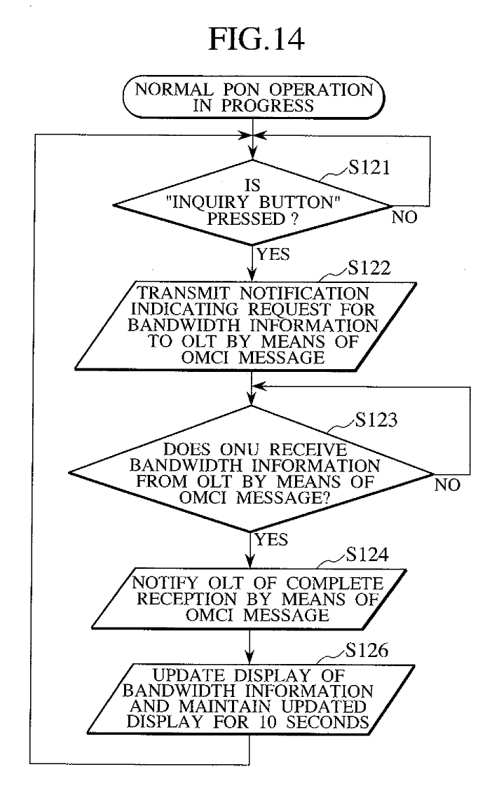

Operations of the ONU, which are related to the request for bandwidth information, are described with reference to FIG. 14. FIG. 14 is a flowchart of bandwidth information request processing of the ONU. The ONU 300 waits for an event that a user presses the inquiry button in S121. When the ONU 300 detects that the inquiry button is pressed (YES in S121), the ONU 300 transmits a notification indicating the request for bandwidth information by means of an OMCI message in S122. The ONU 300 waits to receive an OMCI message indicating information notification from the OLT 200 in S123. When the ONU 300 receives the OMCI message indicating the information notification, the ONU 300 informs the OLT 200 of the complete reception of the OMCI message in S124. The ONU 300 updates its display of the bandwidth information, maintains the display for 10 seconds, and then turns off the display in S126. The ONU 300 waits for an event that the inquiry button is pressed again.

The ONU 300 may inform the phone 400 and/or the PC 410 which are connected with the ONU 300 of the bandwidth information, in addition to the display performed in S126. Alternatively, the ONU 300 may inform the phone 400 and/or the PC 410 which are connected with the ONU 300 of the bandwidth information, without performing the display.

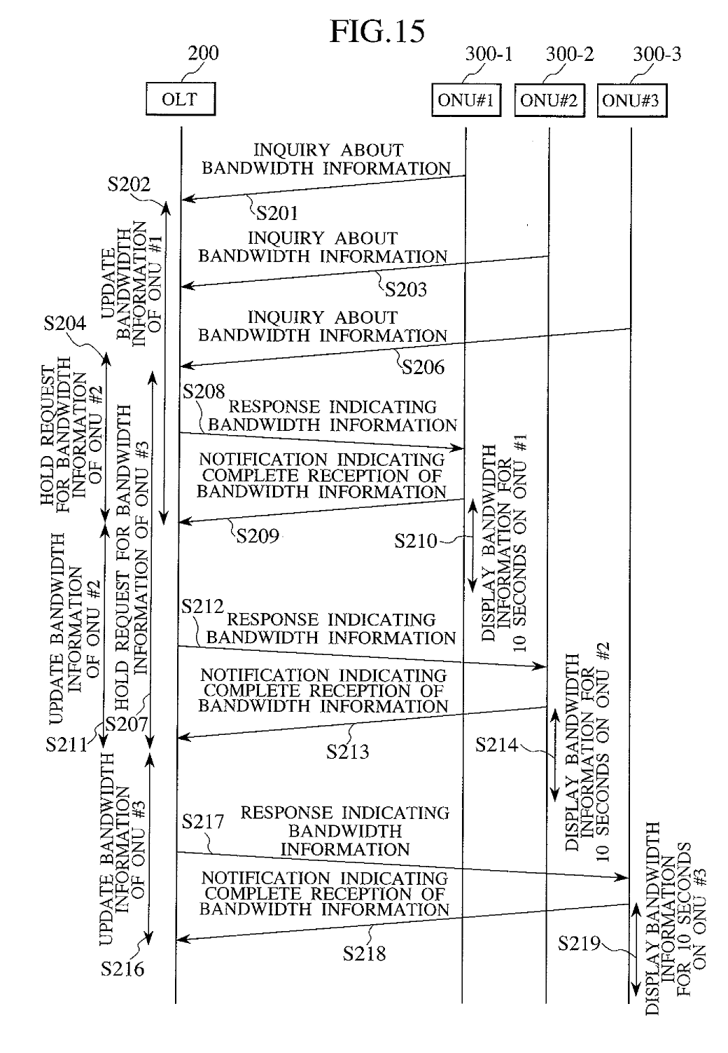

Operations performed by the OLT and three of the ONUs for notifications of bandwidth information are described below with reference to FIG. 15. FIG. 15 is a diagram showing a sequence of the OLT and the three the ONUs. Referring to FIG. 15, the ONU 300-1 transmits a signal to the OLT 200 to inquire the bandwidth information in S201. The OLT 200 starts to update the bandwidth information of the ONU 300-1 in S202. During the time for updating the bandwidth information, the ONUs 300-2 and 300-3 transmits signals to the OLT 200 to inquire their bandwidth information, in S203 and S206, respectively. The OLT 200 holds the signal (bandwidth information request) transmitted by the ONU 300-2 until the (previously performed) operation for updating the bandwidth information of the ONU 300-1 is completed, in S204. Similarly, the OLT 200 holds the signal (bandwidth information request) transmitted by the ONU 300-3 until the (previously performed) operations for updating the bandwidth information of the ONUs 300-1 and 300-2 are completed, in S207.

The OLT 200 transmits to the ONU 300-1 a response indicating the bandwidth information in S208. The ONU 300-1 transmits to the OLT 200 a notification indicating complete reception of the bandwidth information in S209. As a result of Step 209, the bandwidth information of the ONU 300-1 by the OLT 200 is completely updated. The OLT 200 then updates the bandwidth information of the ONU 300-2. The ONU 300-1, which already received the response indicating the bandwidth information, displays the bandwidth information for 10 seconds in S210.

The OLT 200 starts to update the bandwidth information of the ONU 300-2 in S211. The OLT 200 transmits to the ONU 300-2 a response indicating the bandwidth information in S212. The ONU 300-2 transmits to the OLT 200 a notification indicating complete reception of the bandwidth information in S213. When the ONU 300-2 receives the response indicating the bandwidth information, the ONU 300-2 displays the bandwidth information for 10 seconds in S214.

Then, the OLT 200 starts to update bandwidth information of the ONU 300-3 in S216. The OLT 200 transmits to the ONU 300-3 a response indicating the bandwidth information in S217. The ONU 300-3 transmits to the OLT 200 a notification indicating complete reception of the bandwidth information in S218. These operations complete the updating (performed by the OLT 200) of the bandwidth information of the ONU 300-3. When the ONU 300-3 receives the response indicating the bandwidth information, the ONU 300-3 displays the bandwidth information for 10 seconds in S219.

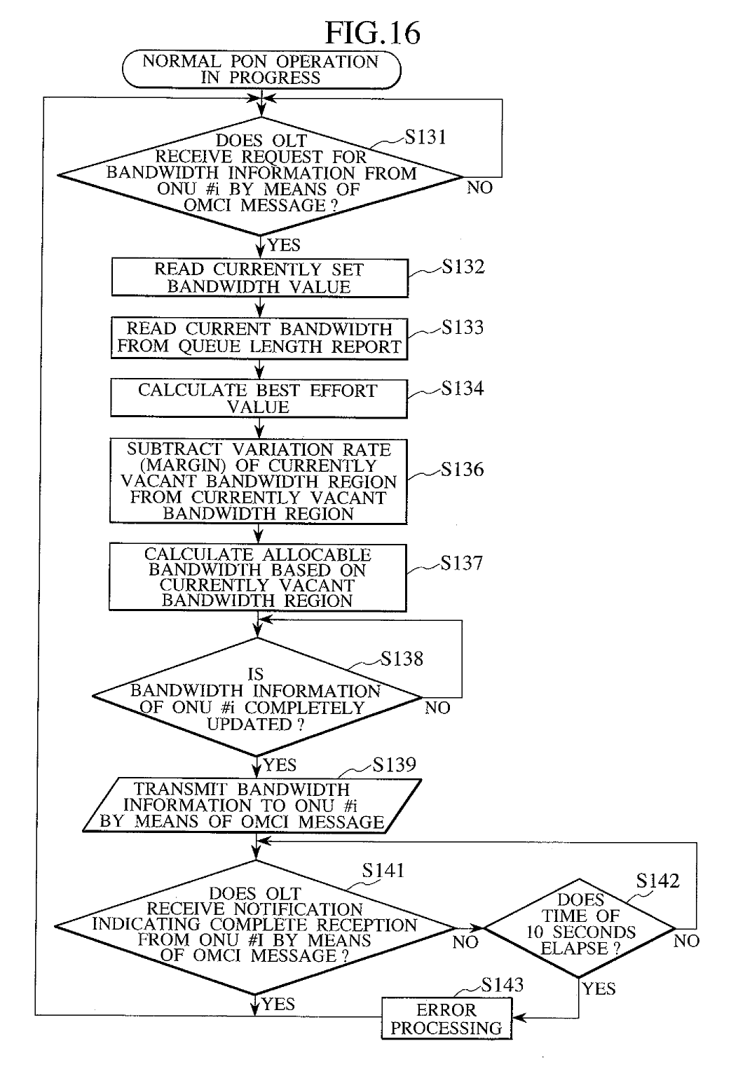

FIG. 16 is another flowchart of operations of the OLT, which are related to the notification of the bandwidth information. The operations shown in FIG. 16 are the same as those shown in FIG. 13, excluding that an operation in S136 is added. Thus, only the operation in S136 is described below. The OLT 200 calculates the best effort value in S134. The OLT 200 estimates that a variation rate of the vacant bandwidth region is 20% and subtracts the variation rate (margin) from the currently vacant bandwidth region, in S136. The OLT 200 calculates an allocable bandwidth region based on the value obtained by the subtraction, in S137.

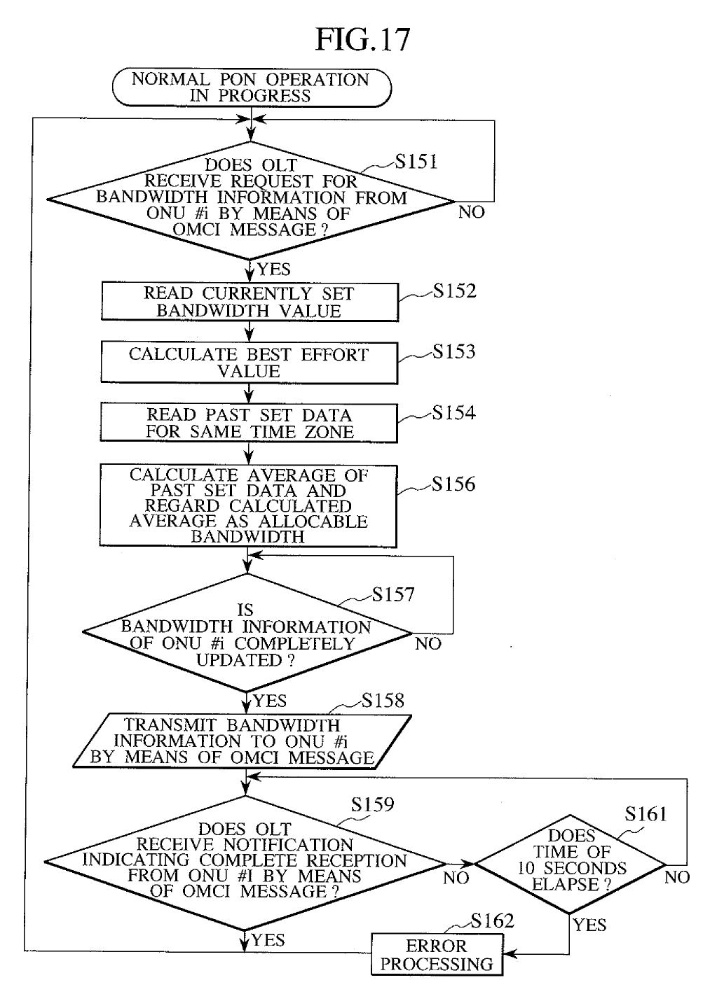

FIG. 17 is still another flowchart of operations of the OLT, which are related to the notification of the bandwidth information. The OLT 200 waits for a request for the bandwidth information from the ONU in S151. When the OLT 200 receives the request from the ONU #i (YES in S151), the OLT 200 reads information on a bandwidth currently set to the ONU #i in S152. The OLT 200 calculates a best effort value based on the information on the currently set bandwidth in S153. The OLT 200 reads past set data for the same time zone as the current time from the past set data memory 271 in S154. The OLT 200 averages the past set data, regards the average value as a currently allocable region, and outputs the average value in S156. The operations in S157 to S162 are the same as the operations in S107 to S112 shown in FIG. 13, and description thereof is omitted.

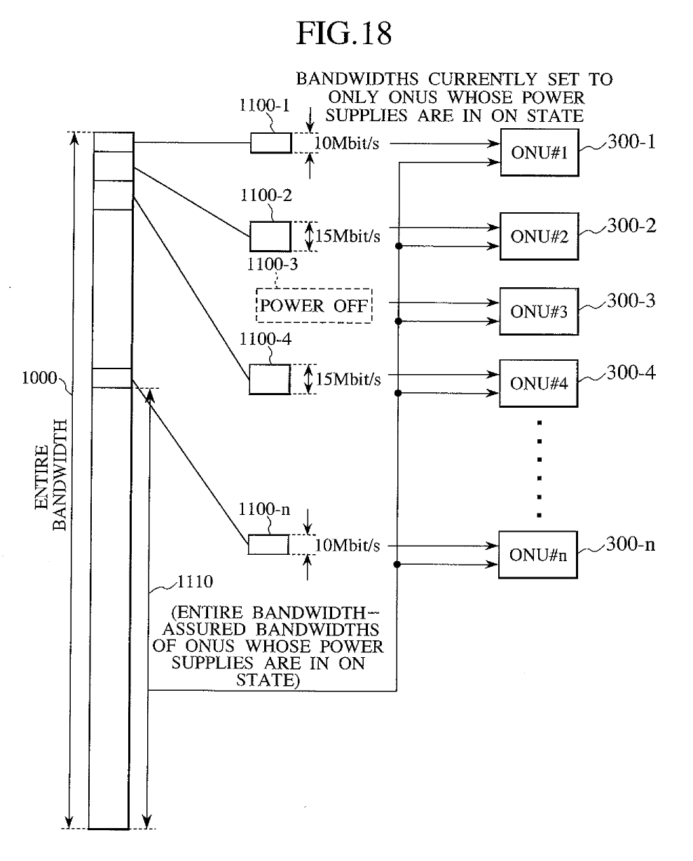

Another embodiment of the calculation of the best effort bandwidth is described below with reference to FIG. 18. FIG. 18 is a diagram showing another setting of the bandwidth used in the optical access network. The sum of assured bandwidths ASBs 1100-1 to 1100-n used for the ONUs 300-1 to 300-n whose power supplies are in an ON state during the calculation of the bandwidth is subtracted from the entire bandwidth 1000. All portions of the remaining bandwidth 1110 are respectively allocated to the ONUs 300-1 to 300-n based on the ratios of the assured bandwidths 1100-1 to 1100-n relative to the total of the assured bandwidths 1100-1 to 1100-n.

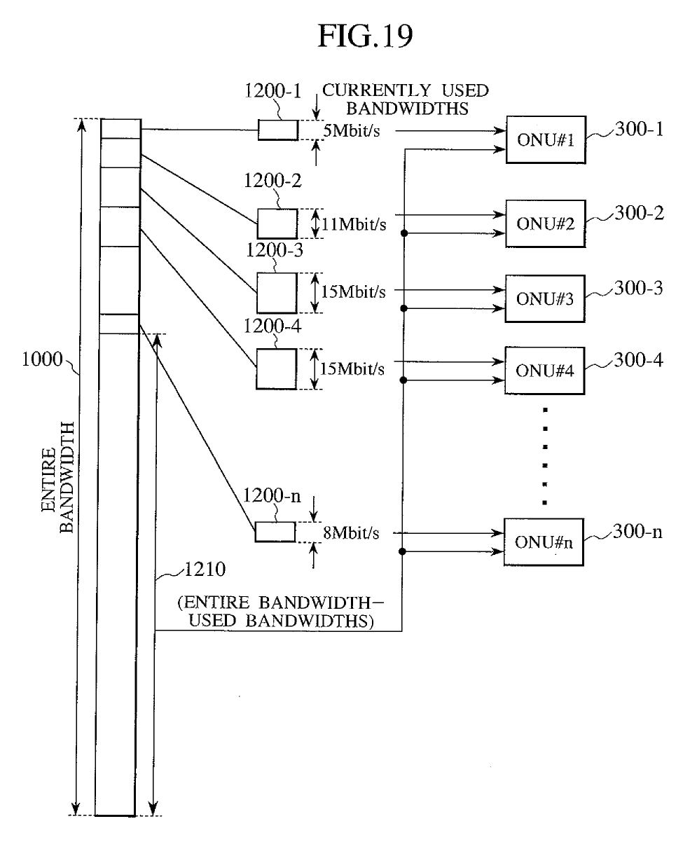

Still another embodiment of the calculation of the best effort bandwidth is described below with reference to FIG. 19. FIG. 19 is a diagram showing still another setting of the bandwidth used in the optical access network. The sum of bandwidths 1200-1 to 1200-n actually used for data communications by the ONUs 300-1 to 300-n during the calculation of the bandwidth is subtracted from the entire bandwidth 1000. All portions of the remaining bandwidth 1210 are respectively allocated to the ONUs 300-1 to 300-n based on the ratios of the bandwidths 1200-1 to 1200-n used for the ONUs 300-1 to 300-n (whose power supplies are currently in the ON state) relative to the total of the bandwidths 1200-1 to 1200-n.

As a modification of the embodiment described above, the terminals 400 and 410 connected with any of the ONUs 300 may electrically transmit and receive signals directly to and from the inquiry button ON/OFF detector 326 and display unit 325 included in the ONU 300. When the signal format(s) used for the terminals 400 and 410 is not compatible with the signal format used for the ONU, the signal format used for the ONU can be converted by means of the CPU. The terminals directly read the information on the set bandwidth and autonomously optimize the communication bandwidth.

As another modification of the embodiment described above, the table of the bandwidth information table section 279 shown in FIG. 9 is written in a server that is provided outside the OLT 200 and connected with the OLT 200, and the terminals 400 and 410 connected with the ONU 300 inquire the server to read the table of the bandwidth information table section 279.

According to the aforementioned embodiment, using the PON system, the ONU user can accurately recognize the setting of the bandwidth used for communications between each ONU and the OLT. Thus, the bandwidth setting can be reflected to setting of an operation of the terminal connected with the ONU. This configuration of the PON system prevents continuous data of a high bit rate, such as streaming video data, from being cut.

What is claimed is:

1. A passive optical network system comprising:
an optical network unit; and
an optical line terminal connected with the optical network unit through an optical fiber, wherein
the optical line terminal has a bandwidth setting information storage section, and
when the optical line terminal receives a bandwidth information inquiry message from the optical network unit, the optical line terminal references the bandwidth setting information storage section and transmits a bandwidth information response message including bandwidth information to the optical network unit.

2. The passive optical network system according to claim 1, wherein
the optical network unit has a display unit which displays the bandwidth information included in the received bandwidth information response message.

3. The passive optical network system according to claim 1, wherein
the optical network unit is connected with a terminal and transmits the bandwidth information included in the received bandwidth information response message to the terminal.

4. The passive optical network system according to claim 3, wherein
the optical network unit transmits the bandwidth information inquiry message to the optical line terminal in response to a request from the terminal.

5. An optical network unit connected with an optical line terminal through an optical fiber, comprising:
a message transmitter; and
a message receiver, wherein
when the message transmitter transmits a bandwidth information inquiry message and the message receiver receives a bandwidth information response message, the optical network unit displays or transfers bandwidth information included in the bandwidth information response message.

6. An optical line terminal connected with an optical network unit through an optical fiber, comprising:
a message transmitter;
a message receiver; and
a bandwidth setting information storage section, wherein
when the message receiver receives a bandwidth information inquiry message from the optical network unit, the optical line terminal references the bandwidth setting information storage section, and the message transmitter transmits a bandwidth information response message including bandwidth information.
